(19) United States
(12) Patent Application Publication
(10) Pub. No.: US 2024/0265835 A1
(43) Pub. Date: Aug. 8, 2024

(54) DISPLAY CONTROL DEVICE, DISPLAY CONTROL METHOD, AND RECORDING MEDIUM

(71) Applicant: HONDA MOTOR CO., LTD., Tokyo (JP)

(72) Inventor: Masamitsu Shiono, Wako-shi (JP)

(21) Appl. No.: 18/543,595

(22) Filed: Dec. 18, 2023

(30) Foreign Application Priority Data
Feb. 7, 2023 (JP) 2023-017019

(51) Int. Cl. G09G 3/00; B60K 35/234; B60K 35/235; G06T 7/60; G06T 7/70

(52) U.S. Cl. CPC G09G 3/001; B60K 35/234; B60K 35/235; G06T 7/60; G06T 7/70; B60K 2360/167; B60K 2360/186; B60K 2360/21; B60K 2360/349; G06T 2207/30201; G06T 2207/30268; G09G 2320/0626; G09G 2354/00; G09G 2380/10

(57) ABSTRACT

A display control device for controlling an operation of a display device that projects an information image onto a screen so as to superimpose the information image on a viewing object being viewed by a user and allow the information image to be viewed by the user, the screen being disposed between the viewing object and the user, the display control device including: a user image acquisition unit that acquires an image of the user, which is captured by a camera; an interpupillary length recognition unit that recognizes an interpupillary length between left and right eyes of the user, based on the image of the user acquired by the user image acquisition unit; and an information-image display control unit that changes brightness of the information image, based on the interpupillary length.

### INCORPORATION BY REFERENCE

The present application claims priority under 35 U.S.C. § 119 to Japanese Patent Application No. 2023-017019 filed on Feb. 7, 2023. The content of the application is incorporated herein by reference in its entirety.

### BACKGROUND OF THE INVENTION

### Field of the Invention

The present invention relates to a display control device, a display control method, and a recording medium.

### Description of the Related Art

Conventionally, for a head-up display (HUD) on a vehicle, there is a proposed configuration in which the viewing distance from a user viewing a virtual image projected by the HUD to the virtual image is changeable, and the brightness of the virtual image is adjusted according to the viewing distance (see, for example, Japanese Patent Laid-Open No. 2019-174693.).

According to the related art, the brightness of the virtual image is changed according to the viewing distance from the user to the virtual image projected by the HUD, thereby reducing the possibility that the user may have a strange feeling as if the brightness of the virtual image has fluctuated, and reducing deterioration of the display quality and visibility of the virtual image.

However, the virtual image projected by the HUD is viewed by the user at his/her discretion as needed, and, therefore, even if the brightness of the virtual image is changed according to the viewing distance as in the related art, the user may feel that the display of the virtual image is annoying. Hence, the present application addresses the problem of superimposing, in a display mode that matches the user's intention, an information image on an object being viewed by the user, and allowing the information image to be viewed by the user.

In order to solve the problem, a purpose of the present application is to improve the visibility. Moreover, this will contribute to a further improvement in traffic safety, and development of a sustainable transportation system.

### SUMMARY OF THE INVENTION

As a first aspect to achieve the purpose, provided is a display control device for controlling an operation of a display device that projects an information image onto a screen so as to superimpose the information image on a viewing object being viewed by a user and allow the information image to be viewed by the user, the screen being disposed between the viewing object and the user, the display control device including: a user image acquisition unit that acquires an image of the user, which is captured by a camera; an interpupillary length recognition unit that recognizes an interpupillary length between left and right eyes of the user, based on the image of the user acquired by the user image acquisition unit; and an information-image display control unit that changes brightness of the information image, based on the interpupillary length.

In the display control device, the information-image display control unit may be configured to set the brightness of the information image when the interpupillary length exceeds a first predetermined length, to be lower than the brightness when the interpupillary length is less than or equal to the first predetermined length.

In the display control device, the information-image display control unit may be configured to set the brightness of the information image when the interpupillary length is less than or equal to a second predetermined length, to be higher than the brightness when the interpupillary length exceeds the second predetermined length.

In the display control device, the display device may be mounted on a vehicle, and configured to project the information image onto a front window of the vehicle as the screen.

As a second aspect to achieve the purpose, provided is a display control method for controlling, by a computer, an operation of a display device that projects an information image onto a screen so as to superimpose the information image on a viewing object being viewed by a user and allow the information image to be viewed by the user, the screen being disposed between the viewing object and the user, the display control method including: a user image acquisition step for acquiring an image of the user, which is captured by a camera; an interpupillary length recognition step for recognizing an interpupillary length between left and right eyes of the user, based on the image of the user acquired in the user image acquisition step; and an information-image display control step for changing brightness of the information image, based on the interpupillary length.

As a third aspect to achieve the purpose, provided is a non-transitory recording medium storing a program for a computer to control an operation of a display device that projects an information image onto a screen so as to superimpose the information image on a viewing object being viewed by a user and allow the information image to be viewed by the user, the screen being disposed between the viewing object and the user, the program causing the computer to function as: a user image acquisition unit that acquires an image of the user, which is captured by a camera; an interpupillary length recognition unit that recognizes an interpupillary length between left and right eyes of the user, based on the image of the user acquired by the user image acquisition unit; and an information-image display control unit that changes brightness of the information image, based on the interpupillary length.

According to the display control device, in a display mode that suits the user's intention, it is possible to superimpose the information image on the object being viewed by the user, and allow the information image to be viewed by the user.

### BRIEF DESCRIPTION OF THE DRAWINGS

FIG. 1 is a configuration diagram of a display control device;

FIG. 2 is a configuration diagram of a vehicle, near a driver seat;

FIG. 3 is flowchart of a process for changing the brightness of an information image;

FIG. 4 is an explanatory view of a display mode of the information image in a situation in which a driver is looking far ahead; and

FIG. 5 is an explanatory view of a display mode of the information image in a situation in which the driver is looking at the information image.

### DETAILED DESCRIPTION OF THE PREFERRED EMBODIMENTS

### 1. Configuration of Display Control Device

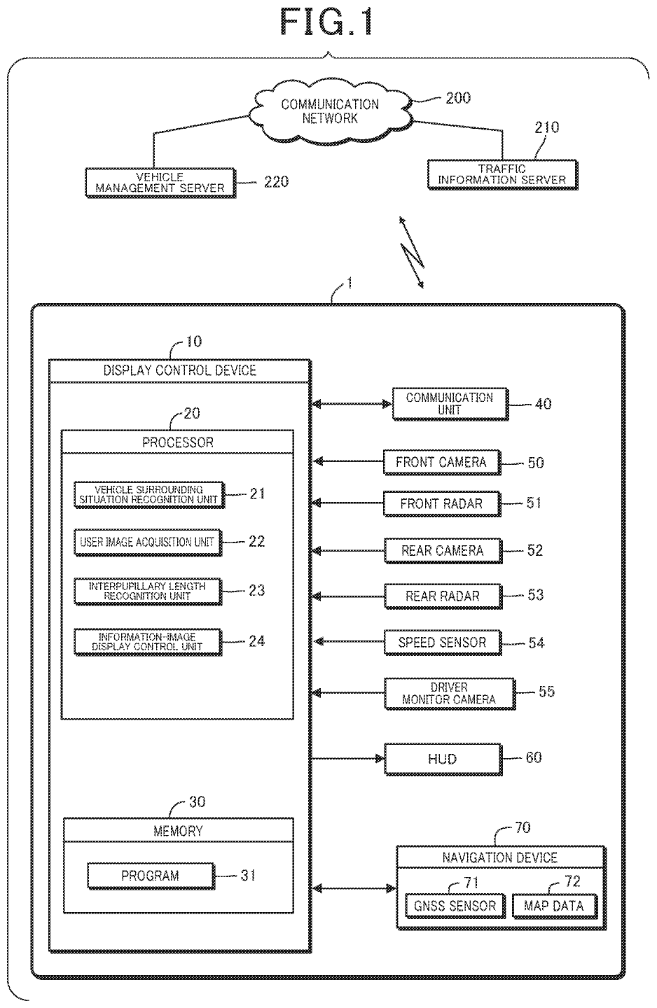

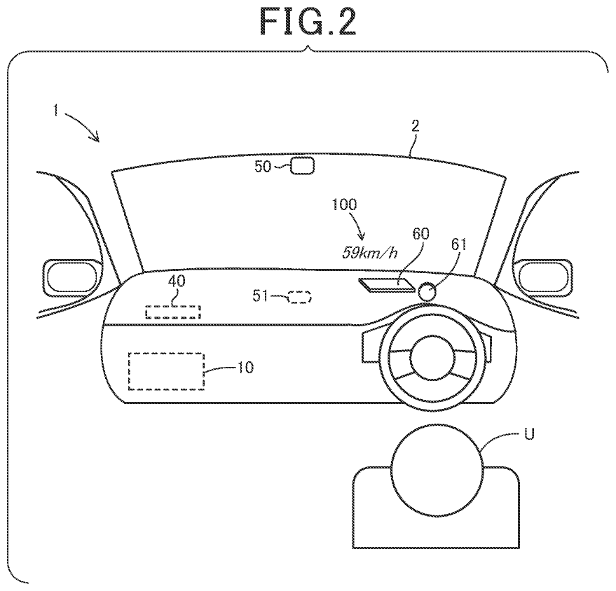

Referring to FIG. 1 and FIG. 2, a configuration of a display control device 10 of the present disclosure will be described. Referring to FIG. 1, the display control device 10 is mounted on a vehicle 1, and is connected to a communication unit 40, a front camera 50, a front radar 51, a rear camera 52, a rear radar 53, a speed sensor 54, a driver monitor camera 55, a head-up display (HUD) 60, a navigation device 70, etc. on the vehicle 1. The driver monitor camera 55 is equivalent to a camera of the present disclosure, and the HUD 60 is equivalent to a display device of the present disclosure.

The communication unit 40 provides communication between external communication systems, such as a traffic information server 210 and a vehicle management server 220, through a communication network 200. The front camera 50 captures an image in front of the vehicle 1, and inputs the image in front to the display control device 10. The front radar 51 detects the location of an object in front of the vehicle 1, and inputs location detection data to the display control device 10.

The rear camera 52 captures an image in rear of the vehicle 1, and inputs the image in rear to the display control device 10. The rear radar 53 detects the location of an object in rear of the vehicle 1, and inputs location detection data to the display control device 10. The speed sensor 54 detects a traveling speed of the vehicle 1, and inputs speed detection data to the display control device 10. The navigation device 70 includes a global navigation satellite system (GNSS) sensor 71 for detecting the current location of the vehicle 1, and map data 72. The navigation device 70 inputs route guidance data to a destination and the like to the display control device 10.

Referring to FIG. 2, the driver monitor camera 55 is disposed on a dashboard or the like of the vehicle 1, captures an image of a driver U of the vehicle 1, and inputs the image of the driver U to the display control device 10. The driver U is equivalent to a user of the present disclosure. The HUD 60 projects an information image 100 indicating the traveling speed of the vehicle 1 and the like onto a front window 2. The front window 2 is equivalent to a screen of the present disclosure. The information image 100 is superimposed on a viewing object (such as a road, a preceding vehicle, an oncoming vehicle, and scenery) in front of the vehicle 1, and is recognized by the driver U.

In FIG. 2, although an example in which the traveling speed of the vehicle 1 detected by the speed sensor 54 is projected as the information image 100 is shown, the information image 100 also includes: a warning image with respect to other vehicles in front or rear of the vehicle 1, which are recognized by a vehicle surrounding situation recognition unit 21; a traffic information image provided from the traffic information server 210; a guide image based on the route guidance data input from the navigation device 70, and the like.

Referring to FIG. 1, the display control device 10 is a control unit constituted by a processor 20, and a memory 30. The processor 20 may be a single processor, or a multi-processor. The memory 30 stores a program 31 for controlling the display control device 10. The program 31 may be read from a recording medium (such as a magnetic disk, an optical disc, and a flash memory) and stored in the memory 30, or may be downloaded from the vehicle management server 220 or the like and stored in the memory 30.

The processor 20 functions as the vehicle surrounding situation recognition unit 21, a user image acquisition unit 22, an interpupillary length recognition unit 23, and an information-image display control unit 24 by reading and executing the control program 31. Here, a process that is executed by the user image acquisition unit 22 is equivalent to a user image acquisition step in a display control method of the present disclosure, and a process that is executed by the interpupillary length recognition unit 23 is equivalent to an interpupillary length recognition step of the present disclosure. Moreover, a process that is executed by the information-image display control unit 24 is equivalent to an information-image display control step of the present disclosure.

The vehicle surrounding situation recognition unit 21 recognizes the situation in front of the vehicle 1, based on the image in front of the vehicle 1 captured by the front camera 50 and the location detection data of the object in front of the vehicle 1 detected by the front radar 51. Moreover, the vehicle surrounding situation recognition unit 21 recognizes the situation in rear of the vehicle 1, based on the image in rear of the vehicle 1 captured by the rear camera 52 and the location detection data of the object in rear of the vehicle 1 detected by the rear radar 53.

The user image acquisition unit 22 acquires an image of the driver U, which is captured by the driver monitor camera 55. The interpupillary length recognition unit 23 extracts image portions of the pupils of the left and right eyes of the driver U from the image of the driver U, thereby recognizing the interpupillary length. The information-image display control unit 24 executes a process for changing the brightness of the information image 100 projected onto the front window 2 by the HUD 60, based on the interpupillary length recognized by the interpupillary length recognition unit 23. The details of this process will be described later.

### 2. Process for Changing Brightness of Information Image

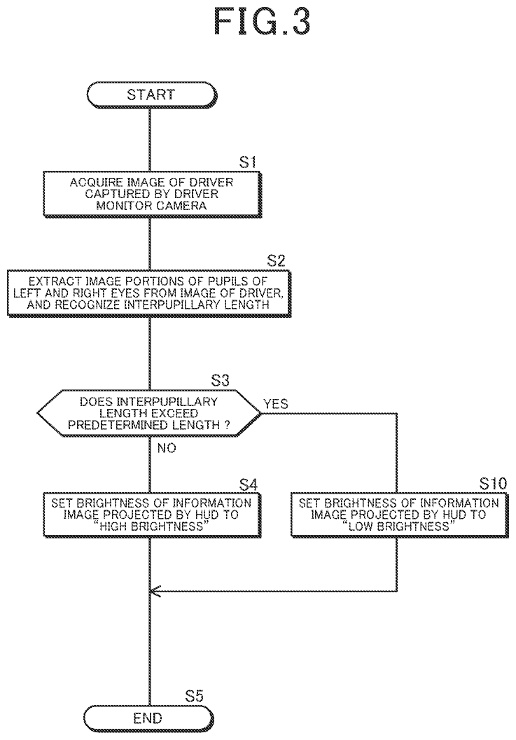

According to the flowchart shown in FIG. 3, the procedure of the process for changing the brightness of the information image 100, which is executed by the display control device 10, will be explained. The display control device 10 repeatedly executes the process according to the flowchart shown in FIG. 3 while the vehicle 1 is traveling.

In step S1 in FIG. 3, the vehicle surrounding situation recognition unit 21 acquires an image of the driver U, which is captured by the driver monitor camera 55. In the following step S2, the interpupillary length recognition unit 23 extracts image portions of the pupils of the left and right eyes from the image of the driver U, thereby recognizing the interpupillary length.

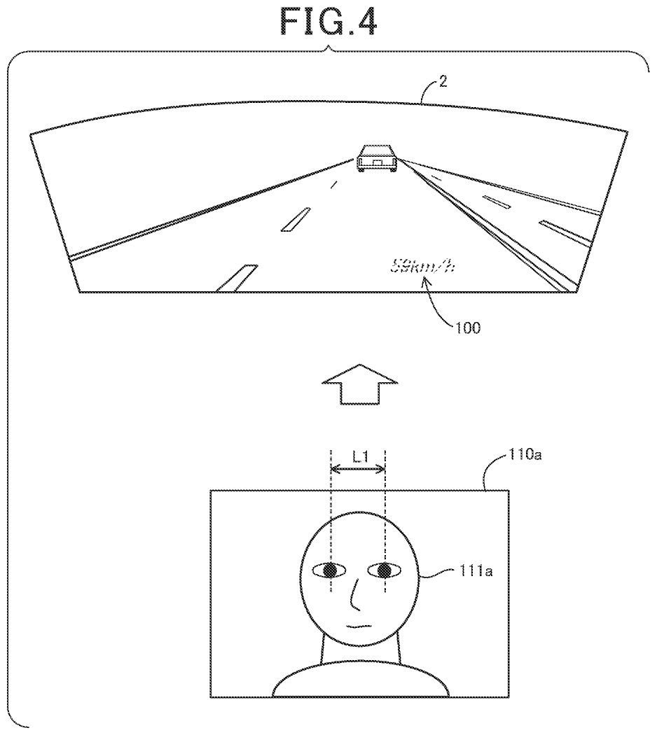

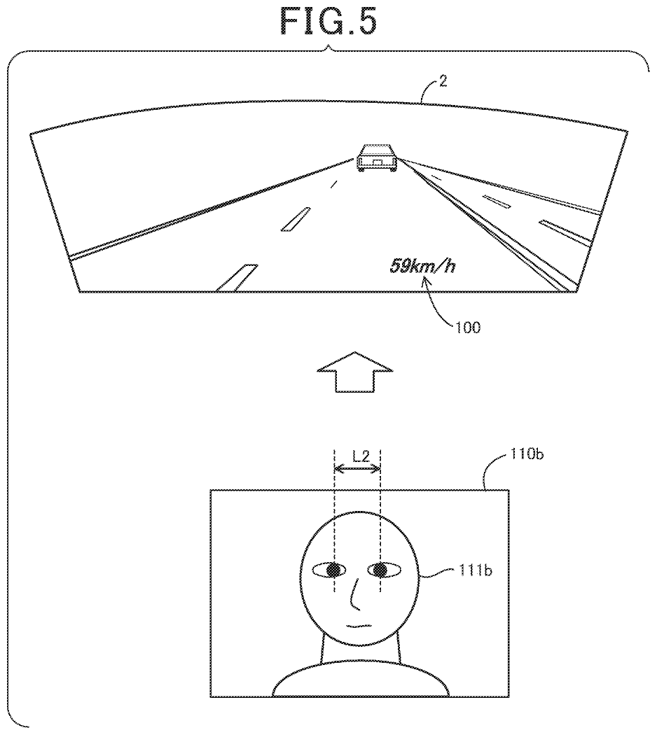

Here, FIG. 4 shows an example in which an interpupillary length L1 is recognized from an image 110a of the driver U. FIG. 4 shows a situation in which the driver U is looking at a distant viewing object, such as a road, in front of the vehicle 1. Moreover, FIG. 5 shows an example in which an interpupillary length L2 is recognized from an image 110b of the driver U. FIG. 5 shows a situation in which the driver U is looking at the information image 100 projected onto the front window 2, and the interpupillary length L2 is shorter than the interpupillary length L1 in the situation of FIG. 4.

In the next step S3, the information-image display control unit 24 determines whether the interpupillary length recognized by the interpupillary length recognition unit 23 exceeds a predetermined length (equivalent to a first predetermined length and a second predetermined length of the present disclosure). Then, the information-image display control unit 24 proceeds to step S10 if the interpupillary length exceeds the predetermined length, or proceeds to step S4 if the interpupillary length is less than or equal to the predetermined length. Here, the predetermined length is set, for example, according to the length between the center positions of the driver's left and right eyes, which is extracted from the image of the driver U.

Step S10 is the process corresponding to a case in which the driver U is looking far ahead through the front window 2, as shown in FIG. 4, and the information-image display control unit 24 sets the brightness of the information image 100 projected onto the front window 2 by the HUD 60 to “low brightness” (for example, a brightness level that is about 50% of the maximum brightness), and advances the process to step S5. Consequently, in the situation in which the driver U is not looking at the information image 100, it is possible to prevent the driver from feeling that the display of the information image 100 is annoying. Note that “low brightness” also includes turning off the information image 100 (brightness 0%).

Step S4 is the process corresponding to a case in which the driver U is looking at the information image 100 projected onto the front window 2, as shown in FIG. 5, and the information-image display control unit 24 sets the brightness of the information image 100 projected onto the front window 2 by the HUD 60 to “high brightness” (for example, the maximum brightness), and advances the process to step S5. This makes it possible for the driver U to easily recognize the information image 100 that the driver U is looking at.

### 3. Other Embodiments

In the above embodiment, the display control device 10 mounted on the vehicle 1 is shown as a display control device of the present disclosure. As another embodiment, the display control device of the present disclosure may be applied to a driving training simulator device, or a game device. In this case, the information image is projected onto a screen which is disposed between the user and a distant display screen on which a pseudo screen during driving, or a game screen is displayed.

In the above embodiment, according to the flowchart in FIG. 3, in step S3, the brightness of the information image 100 projected onto the front window 2 by the HUD 60 is switched between “high brightness” and “low brightness”, according to whether the interpupillary length of the user U exceeds a predetermined length. As another embodiment, the brightness of the information image 100 may be switched to a plurality of levels. For example, a first predetermined length and a second predetermined length shorter than the first predetermined length are set, and the brightness of the information image may be set to “high brightness” if the interpupillary length exceeds the first predetermined length, to “medium brightness” if the interpupillary length is less than the first predetermined length and exceeds the second predetermined length, and to “low brightness” if the interpupillary length is less than or equal to the second predetermined length. Alternatively, the brightness of the information image may be changed linearly in proportion to the interpupillary length.

Note that FIG. 1 is a schematic view showing the configuration of the display control device 10, which is categorized according to major processing contents so as to facilitate understanding of the invention of the present application, and the configuration of the display control device 10 may be configured according to another categorization. Further, the processes to be performed by the respective components may be executed by a single hardware unit, or may be executed by a plurality of hardware units. Furthermore, the processes to be performed by the respective components in the flowchart shown in FIG. 3 may be executed by a single program, or may be executed by a plurality of programs.

### 4. Configurations Supported by the Embodiments

The above-described embodiments are specific examples of the following configurations.
(Configuration 1) A display control device for controlling an operation of a display device that projects an information image onto a screen so as to superimpose the information image on a viewing object being viewed by a user and allow the information image to be viewed by the user, the screen being disposed between the viewing object and the user, the display control device including: a user image acquisition unit that acquires an image of the user, which is captured by a camera; an interpupillary length recognition unit that recognizes an interpupillary length between left and right eyes of the user, based on the image of the user acquired by the user image acquisition unit; and an information-image display control unit that changes brightness of the information image, based on the interpupillary length.

According to the display control device of configuration 1, since the interpupillary length of the left and right eyes of the user changes according to the distance to the object that the user is looking at, the brightness of the information image is changed based on the interpupillary length, and therefore, in a display mode that suits the user's intention, it is possible to superimpose an auxiliary image on the object that the user is looking at, and allow the auxiliary image to be viewed by the user.
(Configuration 2) The display control device according to configuration 1, wherein the information-image display control unit sets the brightness of the information image when the interpupillary length exceeds a first predetermined length, to be lower than the brightness when the interpupillary length is less than or equal to the first predetermined length.

According to the display control device of configuration 2, when the user is assumed to be looking at a distant viewing object because the interpupillary length of the user exceeds the first predetermined length, the brightness of the information image is set to be lower than the brightness when the interpupillary length is less than or equal to the first predetermined length, thereby preventing the user from feeling that the information image is annoying.
(Configuration 3) The display control device according to configuration 1 or configuration 2, wherein the information-image display control unit sets the brightness of the information image when the interpupillary length is less than or equal to a second predetermined length, to be higher than the brightness when the interpupillary length exceeds the second predetermined length.

According to the display control device of configuration 3, when the user is assumed to be looking at the information image nearby because the interpupillary length of the user is less than or equal to the second predetermined length, the brightness of the information image is set to be higher than the brightness when the interpupillary length exceeds the second predetermined length, thereby making it easy for the user to view the information image.
(Configuration 4) The display control device according to any one of configuration 1 to configuration 3, wherein the display device is mounted on a vehicle, and projects the information image onto a front window of the vehicle as the screen.

According to the display control device of configuration 4, the brightness of the information image can be changed, according to the object that the user in the vehicle is looking at.
(Configuration 5) A display control method for controlling, by a computer, an operation of a display device that projects an information image onto a screen so as to superimpose the information image on a viewing object being viewed by a user and allow the information image to be viewed by the user, the screen being disposed between the viewing object and the user, the display control method including: a user image acquisition step for acquiring an image of the user, which is captured by a camera; an interpupillary length recognition step for recognizing an interpupillary length between left and right eyes of the user, based on the image of the user acquired in the user image acquisition step; and an information-image display control step for changing brightness of the information image, based on the interpupillary length.

By executing the display control method of configuration 5 by the controller, it is possible to obtain the same functions and effects as the functions and effects of the display control device of configuration 1.
(Configuration 6) A non-transitory recording medium storing a program for a computer to control an operation of a display device that projects an information image onto a screen so as to superimpose the information image on a viewing object being viewed by a user and allow the information image to be viewed by the user, the screen being disposed between the viewing object and the user, the program causing the computer to function as: a user image acquisition unit that acquires an image of the user, which is captured by a camera; an interpupillary length recognition unit that recognizes an interpupillary length between left and right eyes of the user, based on the image of the user acquired by the user image acquisition unit; and an information-image display control unit that changes brightness of the information image, based on the interpupillary length.

By executing the program of configuration 6 by the controller, it is possible to realize the configuration of the display control device of configuration 1.

### REFERENCE SIGNS LIST

1 vehicle
2 front window (screen)
10 display control device
20 processor
21 vehicle surrounding situation recognition unit
22 user image acquisition unit
23 interpupillary length recognition unit
24 information-image display control unit
30 memory
31 program
40 communication unit
50 front camera
51 front radar
52 rear camera
53 rear radar
54 speed sensor
55 driver monitor camera
60 HUD (display device)
70 navigation device
71 GNSS sensor
72 map data
100 information image
110a, 110b image captured by driver monitor camera
111a, 111b driver's image portion
U driver (user)

What is claimed is:

1. A display control device for controlling an operation of a display device that projects an information image onto a screen so as to superimpose the information image on a viewing object being viewed by a user and allow the information image to be viewed by the user, the screen being disposed between the viewing object and the user, the display control device comprising:
a user image acquisition unit that acquires an image of the user, which is captured by a camera;
an interpupillary length recognition unit that recognizes an interpupillary length between left and right eyes of the user, based on the image of the user acquired by the user image acquisition unit; and
an information-image display control unit that changes brightness of the information image, based on the interpupillary length.

2. The display control device according to claim 1, wherein the information-image display control unit sets the brightness of the information image when the interpupillary length exceeds a first predetermined length, to be lower than the brightness when the interpupillary length is less than or equal to the first predetermined length.

3. The display control device according to claim 1, wherein the information-image display control unit sets the brightness of the information image when the interpupillary length is less than or equal to a second predetermined length, to be higher than the brightness when the interpupillary length exceeds the second predetermined length.

4. The display control device according to claim 1, wherein the display device is mounted on a vehicle, and projects the information image onto a front window of the vehicle as the screen.

5. A display control method for controlling, by a computer, an operation of a display device that projects an information image onto a screen so as to superimpose the information image on a viewing object being viewed by a user and allow the information image to be viewed by the user, the screen being disposed between the viewing object and the user, the display control method comprising:
a user image acquisition step for acquiring an image of the user, which is captured by a camera;
an interpupillary length recognition step for recognizing an interpupillary length between left and right eyes of the user, based on the image of the user acquired in the user image acquisition step; and
an information-image display control step for changing brightness of the information image, based on the interpupillary length.

6. A non-transitory recording medium storing a program for a computer to control an operation of a display device that projects an information image onto a screen so as to superimpose the information image on a viewing object being viewed by a user and allow the information image to be viewed by the user, the screen being disposed between the viewing object and the user, the program causing the computer to function as:
a user image acquisition unit that acquires an image of the user, which is captured by a camera;
an interpupillary length recognition unit that recognizes an interpupillary length between left and right eyes of the user, based on the image of the user acquired by the user image acquisition unit; and
an information-image display control unit that changes brightness of the information image, based on the interpupillary length.
